(19) United States
(12) Patent Application Publication
(10) Pub. No.: US 2012/0286064 A1
(43) Pub. Date: Nov. 15, 2012

(54) CONNECTION-PIPE SEDIMENT PREVENTION DEVICE AND METHOD

(75) Inventors: LIANN-BE CHANG, TAO-YUAN (TW); CHIA-YI YEN, TAO-YUAN (TW); YUAN-HSIAO CHANG, TAO-YUAN (TW)

(73) Assignee: CHANG GUNG UNIVERSITY, Tao-Yuan (TW)

(21) Appl. No.: 13/535,471

(22) Filed: Jun. 28, 2012

(30) Foreign Application Priority Data
May 8, 2011 (TW) 100128017

(51) Int. Cl. B05B 9/00

(52) U.S. Cl. 239/142

(57) ABSTRACT

A connection-pipe sediment prevention device and method. In said connection-pipe sediment prevention device, at least a pressuring element is disposed at an opening of a pipe body of said connection-pipe, and a controller controls reciprocal movements of said pressuring elements, to make suspension liquid to flow in said connection-pipe and not to produce sediment. A nozzle is provided at bottom of said connection-pipe, to spray out said suspension liquid. Said connection-pipe sediment prevention method utilizes same means to make powder distribute evenly in said suspension liquid, so that said suspension liquid is sprayed out evenly from said nozzle. A connection-pipe principle is used, such that said suspension liquid having insoluble powder will not produce sediment, in achieving uniform spray. In addition, it is not required to put in large amount of powder and liquid at one time, thus saving production cost.

### BACKGROUND OF THE INVENTION

1. Field of the Invention

The present invention relates to a technology of preventing sediment in liquid containing non-soluble powder, and in particular to a connection-pipe sediment prevention device and method.

2. The Prior Arts

Presently, in the sphere of fuel cell, solar cell, and fluorescent powder spray, liquid and non-soluble powder are mixed together, and then sprayed out from a nozzle of a spraying device, to produce uniformly sprayed films. However, since the powder is not soluble in the liquid, it is liable to produce sediment. Therefore, stirring or agitation is required to make the liquid flow in the spraying device, so as not to produce sediment.

Refer to FIG. 1 for a schematic diagram of a connection-pipe sediment prevention device according to the prior art. As shown in FIG. 1, in the prior art, for a spraying device, in spraying a suspension liquid containing insoluble powder, a stirring element 10 is used to stir the liquid in a stirring tank 12 in such a way, to prevent sediment of powder in the suspension liquid. Then a circulation pipe 14 is used to guide the stirred suspension liquid to the nozzle 16 to spray out. The remaining suspension liquid is guided back into the stirring tank 12, to continue the circulation repeatedly. Though, in this way, the suspension liquid is stirred evenly in a tank, but it may still produce sediment due to the suspension liquid staying too long in the circulation pipe 14. When the suspension liquid is of low viscosity, the sediment will become serious. Also, due to the large volume of the stirring tank 12 and the long length of the circulation pipe 14, the amount of liquid and powder put in each time are enormous, and that is not cost effective.

Therefore, presently, the design and performance of connection-pipe sediment prevention device are not quite satisfactory, and it has much room for improvements.

### SUMMARY OF THE INVENTION

In view of the problems and drawbacks of the prior art, the present invention provides a connection-pipe sediment prevention device and method, so as to overcome the shortcomings of the prior art.

A major objective of the present invention is to provide a connection-pipe sediment prevention device and method. Wherein, the connection-pipe principle is used to prevent sediment of powder in the suspension liquid, to make the powder distribute evenly in the suspension liquid, so as to spray out the suspension liquid having evenly distributed powder onto an object-to-be-sprayed.

Another objective of the present invention is to provide a connection-pipe sediment prevention device and method, such that the spray can be performed without the need to put in large amount of powder and liquid each time.

A further objective of the present invention is to provide a connection-pipe sediment prevention device and method, that can be used in the sphere of fuel cell, solar cell, and fluorescence powder spray. In order to achieve the objective mentioned above, the present invention provides a connection-pipe sediment prevention device, comprising: a connection-pipe, at least a pressuring element, a nozzle, and a controller. Wherein, the connection-pipe is formed by connecting at least two pipe bodies together, and then the suspension liquid is put into the connection-pipe. The at least a pressuring element is sealed tightly to the upper portion of one of the pipe bodies, such that the reciprocal movements of the pressuring element will make the suspension liquid to flow, so that it is not liable to produce sediment. The nozzle is disposed at the bottom of the connection-pipe, to spray out the suspension liquid. The controller is used to control the movements of the pressuring elements.

The present invention also provides a connection-pipe sediment prevention method, comprising the following steps. Firstly, apply pressure on pipe bodies of the connection-pipe, to make powder distribute evenly in the liquid. Then, open the nozzle at the bottom of the connection-pipe, so that the liquid having evenly distributed powders is sprayed out from the nozzle onto an object-to-be-sprayed.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a connection-pipe sediment prevention device according to the prior art;

FIG. 2 is a schematic diagram of a connection-pipe sediment prevention device according to a first embodiment of the present invention;

FIG. 3 is a flowchart of the steps of a connection-pipe sediment prevention method according to a first embodiment of the present invention;

FIG. 4 is a schematic diagram of a connection-pipe sediment prevention device according to a first embodiment of the present invention when it is in operation;

FIG. 5 is a schematic diagram of a connection-pipe sediment prevention device according to a first embodiment of the present invention when the suspension liquid is sprayed out;

FIG. 6 is a schematic diagram of a connection-pipe sediment prevention device having air outlet holes according to a first embodiment of the present invention;

FIG. 7 is a schematic diagram of a connection-pipe sediment prevention device according to a second embodiment of the present invention when it is in operation; and

FIG. 8 is a flowchart of the steps of a connection-pipe sediment prevention method according to a second embodiment of the present invention.

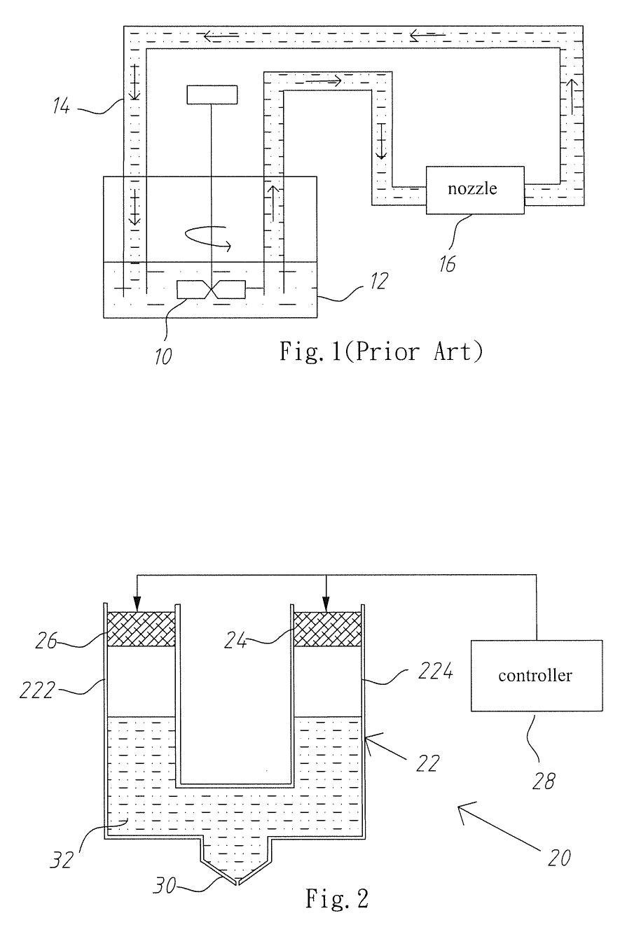

### DETAILED DESCRIPTION OF THE PREFERRED EMBODIMENT

The purpose, construction, features, functions and advantages of the present invention can be appreciated and understood more thoroughly through the following detailed description with reference to the attached drawings.

The present invention provides a connection-pipe sediment prevention device and method. Wherein, a connection-pipe principle is utilized, and pressure is applied to the suspension liquids reciprocally, so that the powders suspended in the liquid is not liable to produce sediment. The present invention can be used in the sphere of fuel cell, solar cell, or fluorescent powder spray of LED.

Refer to FIG. 2 for a schematic diagram of a connection-pipe sediment prevention device according to a first embodiment of the present invention. As shown in FIG. 2, the connection-pipe sediment prevention device 20 includes: a connection-pipe 22, at least a pressuring element 24, a nozzle 30, and a controller 28. Wherein, the connection-pipe 22 is formed by at least two pipe bodies connected together. Herein, two pipe bodies, a first pipe body 222 and a second pipe body 224 are taken as an example for explanation. The first pipe body 222 and the second pipe body 224 are formed into a U-shape. In the connection-pipe 22 is provided with the suspension liquid 32, such that the suspension liquid 32 is formed by liquid and powder, and the materials of which can be selected depending on its requirement. Wherein, the liquid can be made of silicon or epoxy, while the powder can be fluorescence powder or other powder. The at least two pressuring elements 24 and 26 can be pistons or pneumatic valves, so that the pressuring elements 24 and 26 seal closely the openings of the first pipe body 222 and the second pipe body 224. The controller 228 controls the reciprocal movements of the two pressuring elements 24 and 26 in the connection-pipe 22, so as to make the suspension liquid 32 to flow and mix evenly. The nozzle 30, provided on the spray device, and is located on the bottom of the connection-pipe 22 and is in communication with the connection-pipe 22, to spray out the suspension liquid 32.

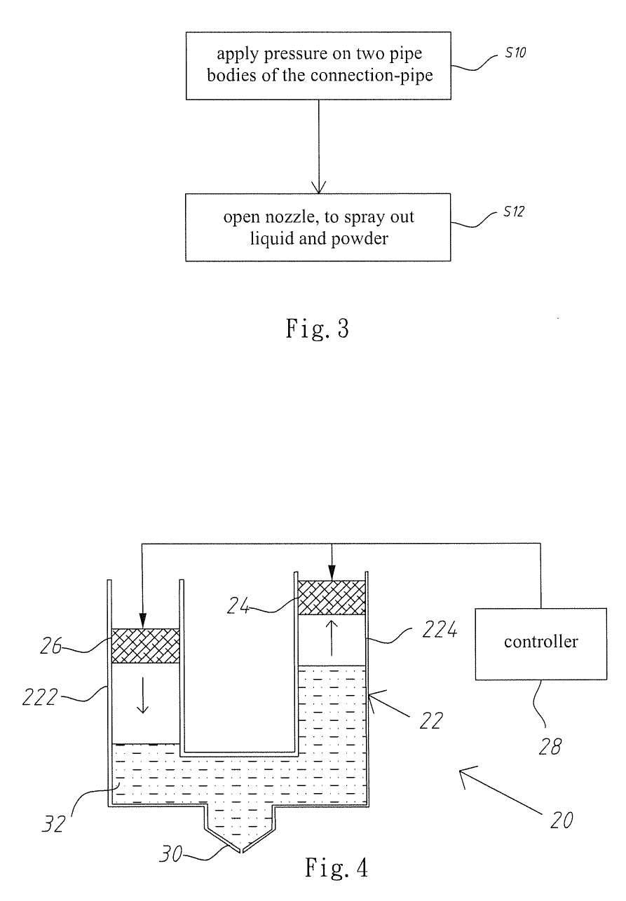

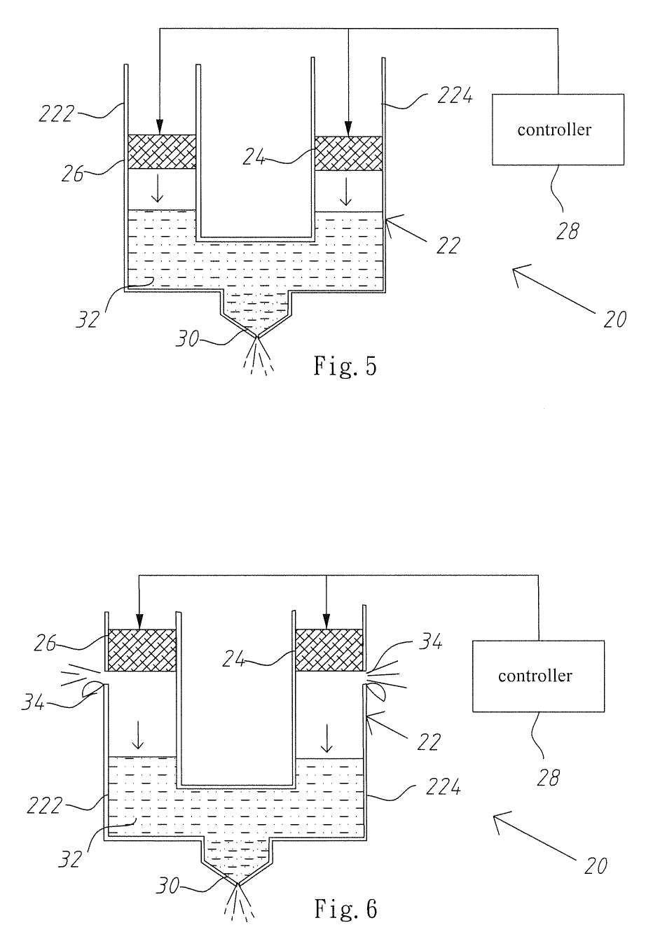

Then, refer to FIG. 3 for a flowchart of the steps of a connection-pipe sediment prevention method according to a first embodiment of the present invention. Also, refer to FIG. 2. Firstly, as shown in step S10, apply pressure on the first pipe body 222 and the second pipe body 224 of the connection-pipe 22, so that the powder is distributed evenly in the liquid. With regard to pressure applying for the two pipe bodies, refer to FIG. 4 for a schematic diagram of a connection-pipe sediment prevention device according to a first embodiment of the present invention when it is in operation. As shown in FIG. 4, firstly, apply pressure in the first pipe body 222, thus due to the pressure applied, the suspension liquid 32 in the connection-pipe 22 will flow downward, to make the suspension liquid 32 in the second pipe body 224 to flow upward. Then, stop applying pressure on the first pipe body 222, and apply pressure on the second pipe body 224. Then, repeatedly apply pressure on the respective pipe bodies alternatively, until the powder is distributed evenly in the suspension liquid 32. In the steps mentioned above, the suspension liquid 32 is made to flow in the connection-pipe 22, so that the powder is distributed evenly in the suspension liquid 32. Subsequently, refer to step S12, open the nozzle 30 at the bottom of the connection-pipe 22, so that the stirred and evenly distributed suspension liquid 32 is sprayed out from the nozzle 30. For the ways the suspension liquid 32 is sprayed out, refer to FIG. 5, wherein, pressure is applied on both of the pipe bodies at the same time, so that the suspension liquid 32 is sprayed out from the nozzle 30. Or, alternatively, refer to FIG. 6 for a schematic diagram of a connection-pipe sediment prevention device having air outlet holes according to a first embodiment of the present invention. Wherein, an air ejection approach is used, so that the air ejection holes 32 are opened to eject the air from the connection-pipe 22, to make the suspension liquid 32 in the connection-pipe 22 to spray out from the nozzle 30.

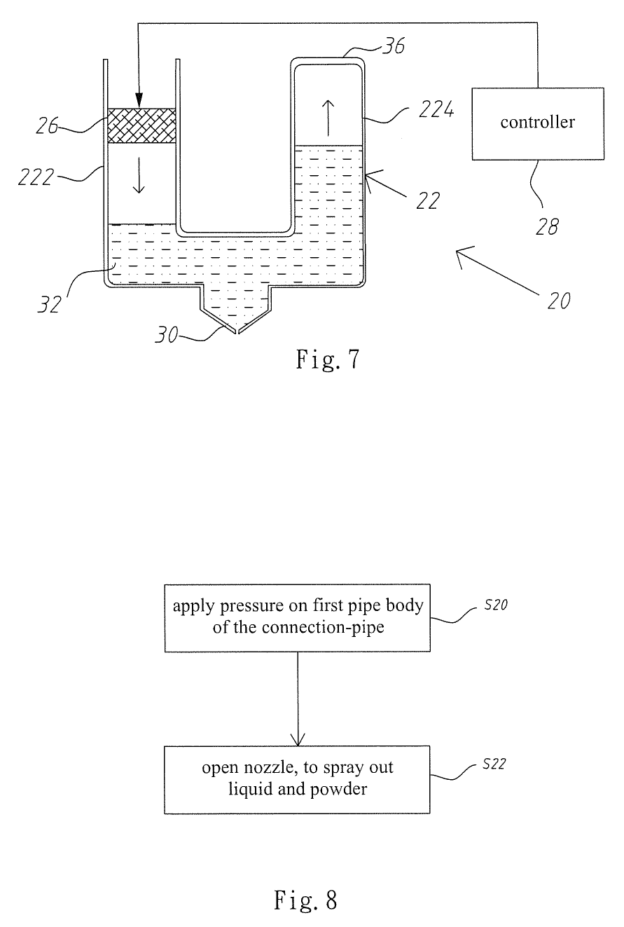

In addition to the embodiment of using two pressuring elements to apply pressure, a single pressuring element 26 can also be used to apply pressure. Refer to FIG. 7 for a schematic diagram of a connection-pipe sediment prevention device according to the second embodiment of the present invention when it is in operation. In the second embodiment, as shown in FIG. 7, in the upper portion of the first pipe body 222 is provided with a pressuring element 26, while the opening on the upper portion of the second pipe body 224 is a closed end 36. The rest of the structure is the same as that of the first embodiment, thus it will not be repeated here for brevity. Refer to FIGS. 7 and 8 at the same time, as shown in step S20, firstly, apply pressure on the first pipe body 222, to make the suspension liquid 32 to flow to the second pipe body 224. Then, stop applying pressure, thus the pressuring element 26 will return to its original position, and the suspension liquid 32 will flow back to the first pipe body 222. In such a way, the suspension liquid 32 is made to flow back and forth in the connection-pipe 22. Then, repeat the actions mentioned above, until the powder in the suspension liquid 32 is distributed evenly in the liquid. Finally, as shown in step S22, open the nozzle at the bottom of the connection-pipe 22, to spray out the liquid together with the powder.

The actions mentioned above are the same as the first embodiment of two pressuring elements, yet the difference is that, in the second embodiment, a closed end 36 is added to the second pipe body 224, and the pressuring element at the upper portion of the second pipe body 224 is eliminated.

Summing up the above, the connection-pipe sediment prevention device and method of the present invention is applicable to the sphere of fuel cell, solar cell, and fluorescence powder spray, to make the suspension liquid having insoluble powder to flow in the connection-pipe, without producing sediment. In this way, the suspension liquid sprayed out can be more uniform, and it is not required to put in large amount of powder and liquid at one time, hereby saving the production cost.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A connection-pipe sediment prevention device, comprising:
a connection-pipe, formed by connecting at least two pipe bodies, to receive suspension liquid;
at least a pressuring element, sealed tightly to an opening of said pipe body, such that reciprocal movements of said pressuring element are used to make said suspension liquid to flow and mix evenly in said connection-pipe;
a nozzle, disposed at bottom of said connection-pipe to spray out said suspension liquid; and
a controller, used to control movements of said pressuring elements.

2. The connection-pipe sediment prevention device as claimed in claim 1, wherein said connection-pipe is of a U-shape.

3. The connection-pipe sediment prevention device as claimed in claim 1, wherein an opening of another pipe body of said connection-pipe is provided with a closed end.

4. The connection-pipe sediment prevention device as claimed in claim 1, wherein said pressuring element is a piston or a pneumatic valve switch.

5. The connection-pipe sediment prevention device as claimed in claim 1, wherein said suspension liquid is formed by liquid containing powder, and said pressuring element is used to make said powder distribute evenly in said suspension liquid.

6. The connection-pipe sediment prevention device as claimed in claim 1, wherein said pressuring element further includes an air exit hole.

7. The connection-pipe sediment prevention device as claimed in claim 1, wherein said nozzle is of a spraying device.

8. The connection-pipe sediment prevention device as claimed in claim 1, wherein at least two said pressuring elements are provided, to seal tightly said two pipe bodies respectively.

9. A connection-pipe sediment prevention method, comprising following steps:
A. firstly, apply pressure on two pipe bodies of a connection-pipe, so that powder distribute evenly in liquid; and
B. then, open a nozzle at bottom of said connecting pipe, so that said liquid and said powder is sprayed out from said nozzle.

10. The connection-pipe sediment prevention method as claimed in claim 9, wherein in said step A, after applying pressure on one of said two pipe bodies, stop applying pressure, then start applying pressure on another pipe body, and repeat actions above, until said powder distributed evenly in said liquid.

11. The connection-pipe sediment prevention method as claimed in claim 9, wherein in said step A, after applying pressure on one of said two pipe bodies, then release pressure, and repeat actions above, until said powder distributed evenly in said liquid.

12. The connection-pipe sediment prevention method as claimed in claim 9, wherein in said step B, apply pressure on said pipe body, to make said liquid and said powder to spray out from said nozzle.

13. The connection-pipe sediment prevention method as claimed in claim 9, wherein in said step B, said pipe body is made to exit air, to make said liquid and said powder to spray out from said nozzle.
